(19) United States
(12) Patent Application Publication
(10) Pub. No.: US 2012/0072149 A1
(43) Pub. Date: Mar. 22, 2012

(54) ESD VERIFICATION APPARATUS, ESD VERIFICATION METHOD AND ESD VERIFICATION PROGRAM

(75) Inventors: Amutha Alagasamy, Yokohama-Shi (JP); Kazuho Nagatsuka, Kamakura-Shi (JP)

(73) Assignee: KABUSHIKI KAISHA TOSHIBA, Tokyo (JP)

(21) Appl. No.: 13/052,976

(22) Filed: Mar. 21, 2011

(30) Foreign Application Priority Data
Sep. 22, 2010 (JP) 2010-211996

(51) Int. Cl. G06F 19/00

(52) U.S. Cl. 702/65

(57) ABSTRACT

An ESD verification apparatus for a semiconductor circuit has a replacement part, a first table making part, a second table making part, a third table making part, a fourth table making part, a fifth table making part, a comparator and an indicator. The indicator indicates to an operator a combination and a path of the corresponding pads when the comparator determines that current-flowing-easiness of a current path via the ESD protection element does not coincide with current-flowing-easiness of a current path not via the ESD protection element between any pads in the plurality of pads.

### CROSS REFERENCE TO RELATED APPLICATIONS

This application is based upon and claims the benefit of priority from the prior Japanese Patent Application No. 2010-211996, filed on Sep. 22, 2010, the entire contents of which are incorporated herein by reference.

### FIELD

Embodiments of the present invention relate to an ESD (Electrostatic Discharge) verification apparatus, an ESD verification method and an ESD verification program, for performing ESD verification to a semiconductor circuit having ESD protection elements.

### BACKGROUND

Some semiconductor circuits (for example, an analog LSI) are required to pass a strict surge test because they are used under severe environmental conditions. In the surge test, a high voltage is applied between pads. It may cause a large surge current flowing between pads, thereby damaging a semiconductor circuit. The damage is mainly due to the existence of current paths of low impedance via PN junctions in a semiconductor circuit. A semiconductor circuit may also be damaged by a large surge current that flows from a surge-applied pad to a ground pad through a parasitic element in the semiconductor circuit.

This type of surge current cannot be detected in ordinary operational simulation. Operational simulation may be performed in a surge condition. It is, however, time consuming and thus difficult to perform operational simulation in a surge condition for all pad pairs.

A device such as an electric motor and a speaker that contains an inductor element is connected to the output stage of a motor driver, an audio amplifier, etc. When a voltage at the output stage varies drastically due to surge, an electromotive force is generated in the inductor element of the device. The electromotive force may cause a large surge current flowing in the device, resulting in damaging the device and the peripheral circuits.

Especially, when a negative voltage is applied to the device due to surge, an unexpected parasitic element may act to cause a large surge current flowing in the device and the peripheral circuit components to damage them. It is difficult to predict the adverse effects of this type of surge beforehand by operational simulation.

Some patent documents disclose electrostatic discharge (ESD) analysis techniques. The conventional ESD analysis techniques, however, do not assume analysis of the current paths via PN junctions, gate-to-source capacitance and the like in a semiconductor circuit. It is thus impossible to perform accurate ESD analysis with the conventional ESD analysis techniques.

### BRIEF DESCRIPTION OF THE DRAWINGS

FIG. 1 is a block diagram schematically illustrating the configuration of an ESD verification apparatus according to an embodiment;

FIG. 2 is a flowchart explaining a processing operation of the ESD verification apparatus of FIG. 1;

FIG. 3 is a view explaining an example of a replacement process in step S2 of FIG. 2;

FIG. 4 is a view of circuit diagrams that indicate an example in which the replacement process of step S2 is performed to a practical semiconductor circuit;

FIG. 5 is a view explaining a directed-path graph;

FIG. 6 is a view explaining a process of making a first table;

FIG. 7 is a view explaining a process of making a second table;

FIG. 8 is a view explaining a process of making a third table;

FIG. 9 is a view explaining a process of making a fourth table;

FIG. 10 is a view explaining a process of step S13;

FIG. 11 is another view explaining the process of step S13;

FIG. 12 is a view explaining a process of making a fifth table; and

FIG. 13 is a view showing a state in which electrostatic surge is applied to a VCCA pad.

### DETAILED DESCRIPTION

An ESD verification apparatus for a semiconductor circuit which comprises a plurality of pads, an internal circuit connected to the pads and at least one of an ESD protection element connected to two pads in the plurality of pads, comprises as follows. A replacement part replaces each PN junction part in the internal circuit and the ESD protection element, a gate-to-source capacitance and a capacitor with a rectifier, respectively. A first table making part makes a first table which stores a numerical value expressing current-flowing-easiness of a current path flowing from one end to another end of the ESD protection element between the two pads connected to the ESD protection element for each of the ESD protection element. A second table making part makes a second table which stores a numerical value expressing current-flowing-easiness of a current path flowing from another end to one end of the ESD protection element between the two pads connected to the ESD protection element for each of the ESD protection element. A third table making part makes a third table which selects and stores a numerical value expressing current-flowing-easiness of a current path flowing more easily in current paths between two pads connected to the ESD protection element in the first and second tables. A fourth table making part makes a fourth table which stores numerical values expressing current-flowing-easiness of all current paths via the ESD protection element between any pads among the plurality of pads based on the third table. A fifth table making part makes a fifth table which stores numerical values expressing current-flowing-easiness between any pads in the plurality of pads at a state of removing all the ESD protection element from the semiconductor circuit. A comparator compares current-flowing-easiness of a current path via the ESD protection element with current-flowing-easiness of a current path not via the ESD protection element between any pads in the plurality of pads based on the fourth and fifth tables. An indicator indicates to an operator a combination and a path of the corresponding pads when the comparator determines that current-flowing-easiness of a current path via the ESD protection element does not coincide with current-flowing-easiness of a current path not via the ESD protection element between any pads in the plurality of pads.

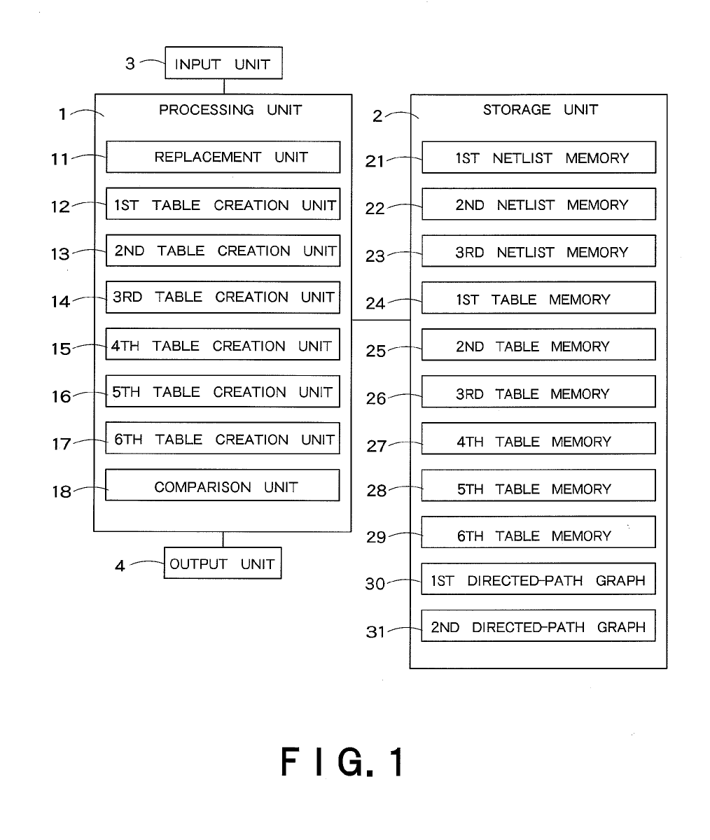

Embodiments will now be explained with reference to the accompanying drawings. FIG. 1 is a block diagram schematically illustrating the configuration of an ESD verification apparatus according to an embodiment. The ESD verification apparatus of FIG. 1 can perform ESD analysis of a semiconductor circuit. More specifically, it performs analysis of whether the connections of ESD protection elements in a semiconductor circuit are correct and whether there is a path through which a large current flows between pads in the semiconductor circuit.

The ESD protection elements according to this embodiment are connected between pads in a semiconductor circuit. A specific configuration of the ESD protection element may be several types of circuit elements, such as, a diode and a thyristor. The ESD protection element may also be configured with a combination of a plurality of circuit elements.

The ESD verification apparatus of FIG. 1 has a processing unit 1 for performing ESD analysis, a storage unit 2 for storing several types of data used in the processing unit 1, an input unit 3 for inputting ESD analysis conditions and the like, and an output unit 4 for outputting the results of ESD analysis.

At least part of the ESD verification apparatus of FIG. 1 may be configured with hardware. Or, at least part of the functions of the ESD verification apparatus may be achieved with a program that runs on, for example, a general-purpose PC or workstation.

The processing unit 1 of the ESD verification apparatus has a replacement unit 11, a first table making unit 12, a second table making unit 13, a third table making unit 14, a fourth table making unit 15, a fifth table making unit 16, a sixth table making unit 17, and a comparison unit 18.

The replacement unit 11 replaces PN junctions and gate-to-source capacitances included in internal circuits and the ESD protection elements connected between pads of the semiconductor circuit, with rectifiers (for example, a diode), respectively.

The first table making unit 12 makes a first table which stores numerical values expressing current-flowing-easiness of a current path from one end (for example, an anode) of the ESD protection element connected between two pads to the other end (for example, a cathode) thereof, for each ESD protection element.

The second table making unit 13 makes a second table which stores numerical values expressing current-flowing-easiness of a current path from the other end (for example, a cathode) of the ESD protection element connected between two pads to one end (for example, an anode) thereof, for each ESD protection element.

The third table making unit 14 combines the first and second tables to make a third table which selects and stores numerical values expressing current-flowing-easiness of the current path flowing more easily in current paths between two pads connected to the ESD protection element in the first and second tables 12 and 13.

The fourth table making unit 15 makes a fourth table which stores numerical values expressing current-flowing-easiness of every current path via the ESD protection element between any pads among a plurality of pads.

The fifth table making unit 16 makes a fifth table which stores numerical values expressing current-flowing-easiness between any pads among a plurality of pads at a state of removing all ESD protection elements from the semiconductor circuit.

The sixth table making unit 17 makes a sixth table which stores numerical values expressing current-flowing-easiness of a current path between two pads each connected to the ESD protection element, for each ESD protection element.

The comparison unit 18 compares, based on the fourth and fifth tables, current-flowing-easiness of a current path via an ESD protection element with current-flowing-easiness of a current path not via an ESD protection element, between any pads. More specifically, the comparison unit 18 determines that there is a problem when the numerical values of the fourth and fifth tables are different from each other.

The output unit 4 indicates to an operator the corresponding pair of pads and paths between the pair when the numerical values of the fourth and fifth tables are different from each other. There is no limitation about the indicated form. For example, the circuit diagram of a semiconductor circuit to be analyzed may be displayed on a display apparatus, with emphasis display of the problematic circuit elements or connection nodes.

The storage unit 2 has a first netlist memory 21 for storing a first netlist, a second netlist memory 22 for storing a second netlist, a third netlist memory 23 for storing a third netlist, a first table memory 24 for storing a first table, a second table memory 25 for storing a second table, a third table memory 26 for storing a third table, a fourth table memory 27 for storing a fourth table, a fifth table memory 28 for storing a fifth table, a sixth table memory 29 for storing a sixth table, a first directed-path graph memory 30 for storing a first directed-path graph, and a second directed-path graph memory 31 for storing a second directed-path graph.

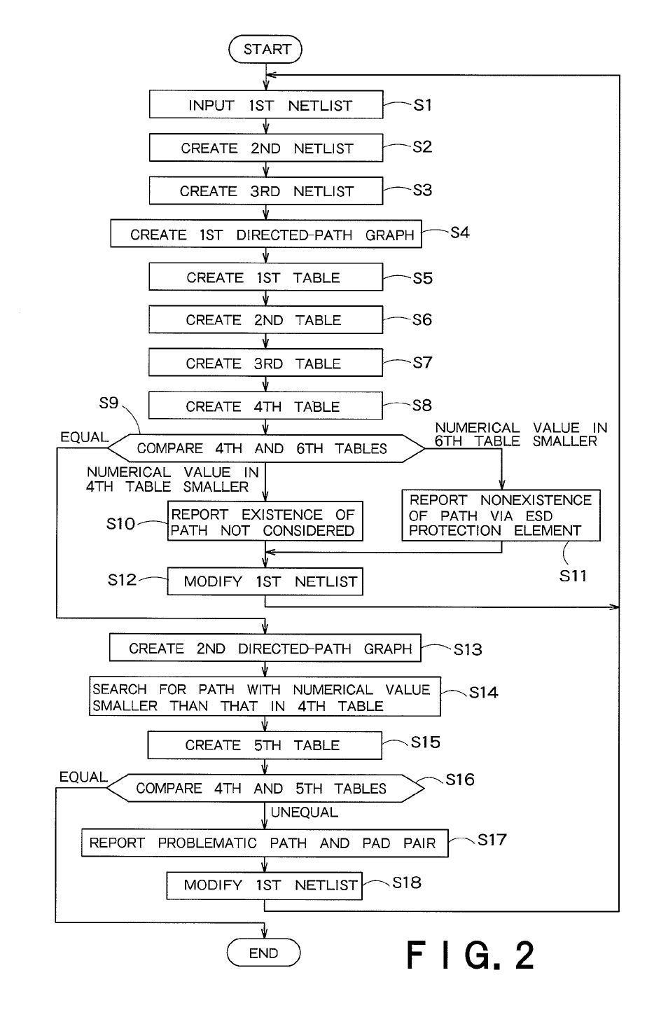

FIG. 2 is a flowchart explaining a processing operation of the ESD verification apparatus of FIG. 1. Hereinbelow, a processing operation of the ESD verification apparatus of FIG. 1 will be explained based on the flowchart.

Firstly, a netlist (referred to as a first netlist, hereinafter) of a semiconductor circuit for ESD analysis is input through the input unit 3 (step S1). The first netlist is stored in the first netlist memory 21. The first netlist is made by an apparatus different from the ESD verification apparatus. Or, the first netlist may be made in the ESD verification apparatus and loaded through a data bus and the input unit 3, and the like.

Next, PN junctions and gate-to-source capacitance are extracted from an internal circuit model and an ESD protection element model in the first netlist and replaced with diodes or parasitic diodes (referred to as a diode for short, hereinafter), thus making a new netlist (referred to as a second netlist, hereinafter), (step S2). The second netlist is stored in the second netlist memory 22.

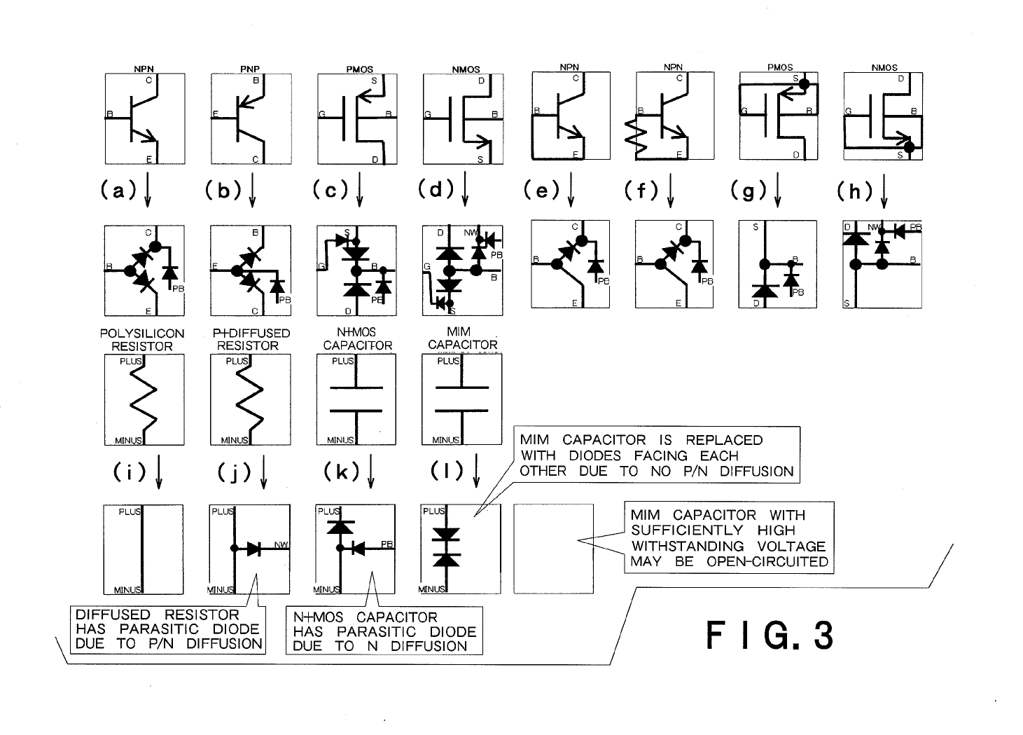

FIG. 3 is a view explaining an example of a replacement process in step S2 of FIG. 2. In an NPN transistor of FIG. 3(a), PN junctions are formed between a base and a collector, the base and an emitter, and a substrate PB and the collector, respectively. The PN junctions are thus replaced with diodes, respectively. The same is applied to a PNP transistor of FIG. 3(b).

In a PMOS transistor of FIG. 3(c), PN junctions are formed between a source and a gate, and a drain and the gate. The PN junctions are thus replaced with diodes, respectively. Gate-to-source capacitance is also replaced with a diode. The same is applied to an NMOS transistor of FIG. 3(d).

In an NPN transistor of FIG. 3(e), a base and an emitter are short-circuited. Therefore, a diode between the base and emitter is omitted. The same is applied to FIG. 3(f).

In a PMOS transistor of FIG. 3(g), a source and a gate are short-circuited. Therefore, a diode between the source and gate is omitted. The same is applied to FIG. 3(h).

A polysilicon resistor of FIG. 3(i) has no PN junction and hence is replaced with a short circuit. A diffused resistor in FIG. 3(j) has a PN junction and hence the PN junction is replaced with a diode.

An N⁺ MOS capacitor of FIG. 3(k) has an internal PN junction and hence the PN junction is replaced with a diode, with gate-to-N⁺ diffusion capacitance being replaced with a diode, like an MOS transistor. In contrast, a MIM capacitor of FIG. 3(l) has no PN junction and hence there is no path like a direct current path between the electrodes. Therefore, the MIM capacitor is replaced with diodes that face each other. Or, the MIM capacitor may be replaced with open-circuited if it has a sufficiently high withstanding voltage.

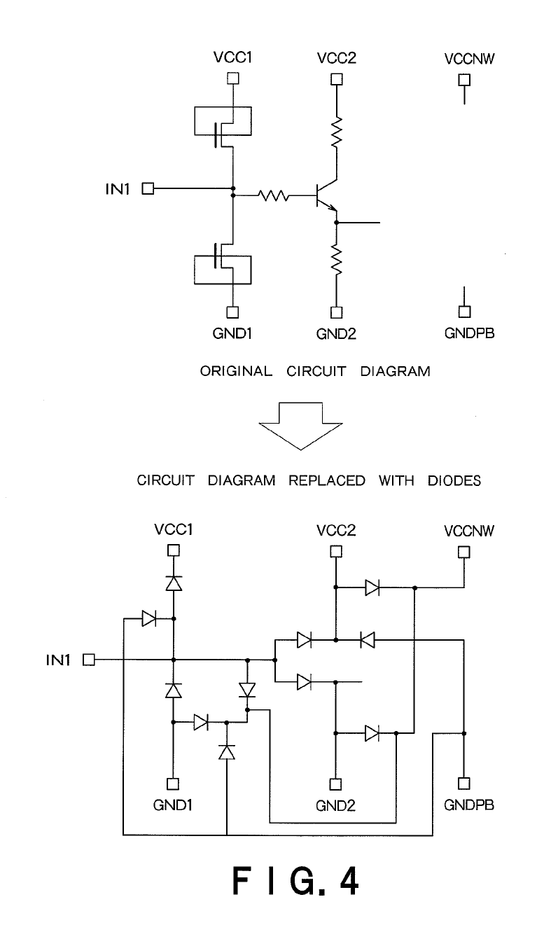

FIG. 4 is a view showing circuit diagrams that indicate an example in which the replacement process of step S2 is performed to a practical semiconductor circuit. Shown on the left side of FIG. 4 is an original circuit diagram that corresponds to the first netlist. Shown on the right side of FIG. 4 is a circuit diagram after the replacement process is performed. As shown, MOS transistors and diffused resistors are replaced with diodes, respectively.

When the process in step S2 of FIG. 2 is complete, a contraction process is performed to remove diodes in which the anode and cathode are short-circuited to make a third netlist by simplifying the second netlist (step S3). The third netlist is stored in the third netlist memory 23.

Next, based on the third netlist, a directed-path graph (referred to as a first directed-path graph, hereinafter) is made (step S4). The first directed-path graph contains numerical values expressing current-flowing-easiness of a current path via an ESD protection element. The first directed-path graph is stored in the first directed-path graph memory 30.

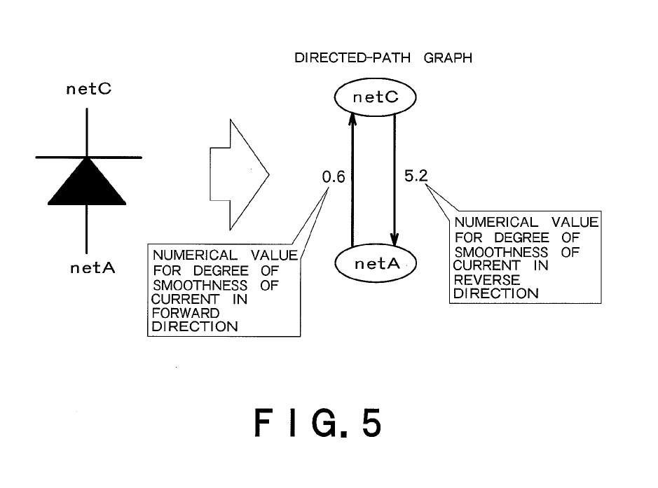

FIG. 5 is a view explaining a directed-path graph. The directed-path graph is a graph of numerical values indicating current-flowing-easiness of a current path via an ESD protection element between two pads. For example, as shown in FIG. 5, when the ESD protection element is a diode, a voltage drop value in a forward direction can be adopted as the numerical value of a current path in the forward direction and a breakdown voltage value can be adopted as the numerical value of the current path in the reverse direction. Moreover, when the gate-to-source capacitance of a MOS transistor is replaced with a diode, a ratio Vgs/Vsg of a breakdown voltage between the gate and source can be adopted as the numerical value indicating current-flowing-easiness. Vgs is a breakdown voltage of a MOS transistor when the gate and source are at a high and a low potential, respectively. Vsg is a breakdown voltage of a MOS transistor when the source and gate are at a high and a low potential, respectively. In the diode corresponding to the MIM capacitor, the numerical value may be 0 in the forward direction, and a breakdown voltage of the MIM capacitor may be selected as the numerical value expressing current-flowing-easiness in the reverse direction.

The directed-path graph indicates that a current flows more as the numerical value is smaller. Therefore, it is possible to grasp current-flowing-easiness simply by comparing the numerical values for each path.

In step S4 described above, a current path between pads in which the ESD protection element passes through in the forward direction is searched. Then, an anode of a diode obtained by replacing the PN junction or gate-to-source capacitance of the ESD protection element is set as a starting point of a directed path. The directed path is a path from the anode of the diode to any pad or an anode of a diode in the other ESD protection element. Then a numerical value expressing current-flowing-easiness is set for the searched directed path.

When a plurality of directed paths exist between the anode of a diode of an ESD protection element and a pad or the anode of a diode of another ESD protection element, the sum of numerical values each indicating the current-flowing-easiness of the respective directed paths is adopted as the numerical value.

When there is a plurality of paths each existing between the anode of a diode of an ESD protection element and a pad or the anode of a diode of another ESD protection element, a path having the smallest sum of numerical values is selected among the paths. The path search ends, for example, when the sum of numerical value of a newly found path exceeds X1 on the way of calculating the sum, X1 being the minimum value of the sum of numerical value. Then, calculation of numerical values is performed for another path. For each node of a semiconductor circuit where no path is found, a very large number (such as, “99999”) is set in order to indicate that no path exists in that node.

In the above described way, the first table is made (step S5) that shows the smallest sum of numerical values each indicating the current-flowing-easiness of a path from the anode of a diode of an ESD protection element to each pad or the anode of a diode of another ESD protection element, between any pads having ESD protection elements connected therebetween.

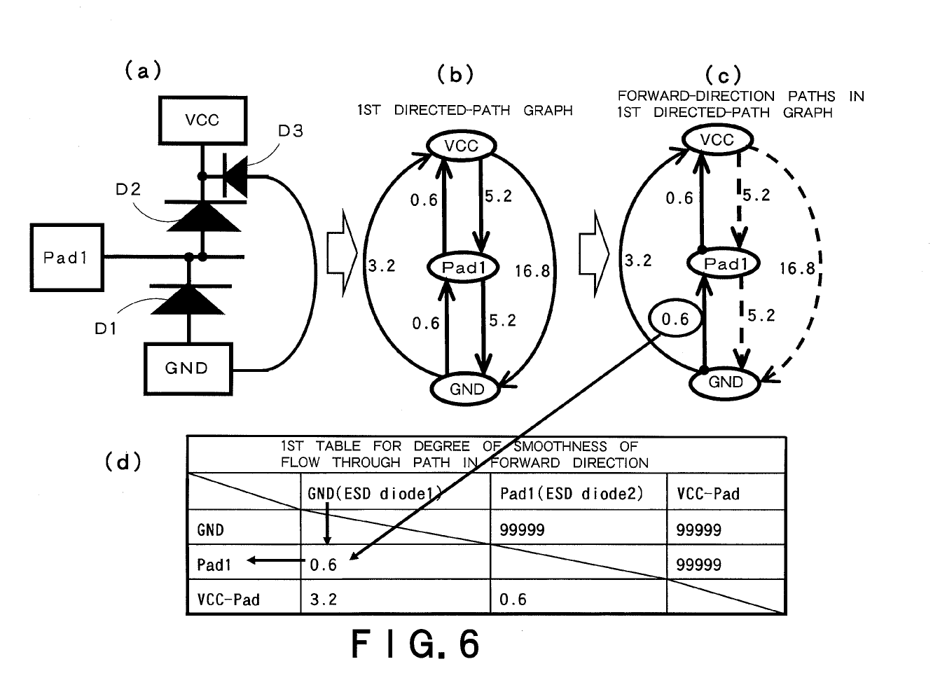

FIG. 6 is a view explaining a process of making the first table. The circuit of FIG. 6(a) is an example in which a diode D1 is provided in an ESD protection element and diodes D2 and D3 are provided in another ESD protection element. The anode and cathode of the diode D1 are connected to a GND pad and a pad P1, respectively. The anode and cathode of the diode D2 are connected to the Pad P1 and a VCC pad, respectively. The diode D3 is connected between the VCC and GND pads.

FIG. 6(b) is a first directed-path graph corresponding to the circuit of FIG. 6(a). Indicated in the first directed-path graph are the numerical values that indicate the current-flowing-easiness from the anode of the diode D1 of the ESD protection element to the GND pad, the Pad P1 (the anode of the diode D2) or the VCC pad.

FIG. 6(c) indicates paths in the forward direction with a solid line and paths in the reverse direction with a broken line, among the paths of FIG. 6(b).

FIG. 6(d) is a first table corresponding to FIG. 6(c). In the first table of FIG. 6(d), a very large value (such as, “99999”) is set for the paths in the reverse direction whereas the numerical values of FIG. 6(c) are denoted along the paths in the forward direction.

Next, an anode of a diode in an ESD protection element in the first directed path graph is set as a starting point. A path from the anode of the diode to any pad or an anode of a diode in the other ESD protection element is searched in order to make a second table which stores numerical values expressing current-flowing-easiness in the reverse direction (step S6).

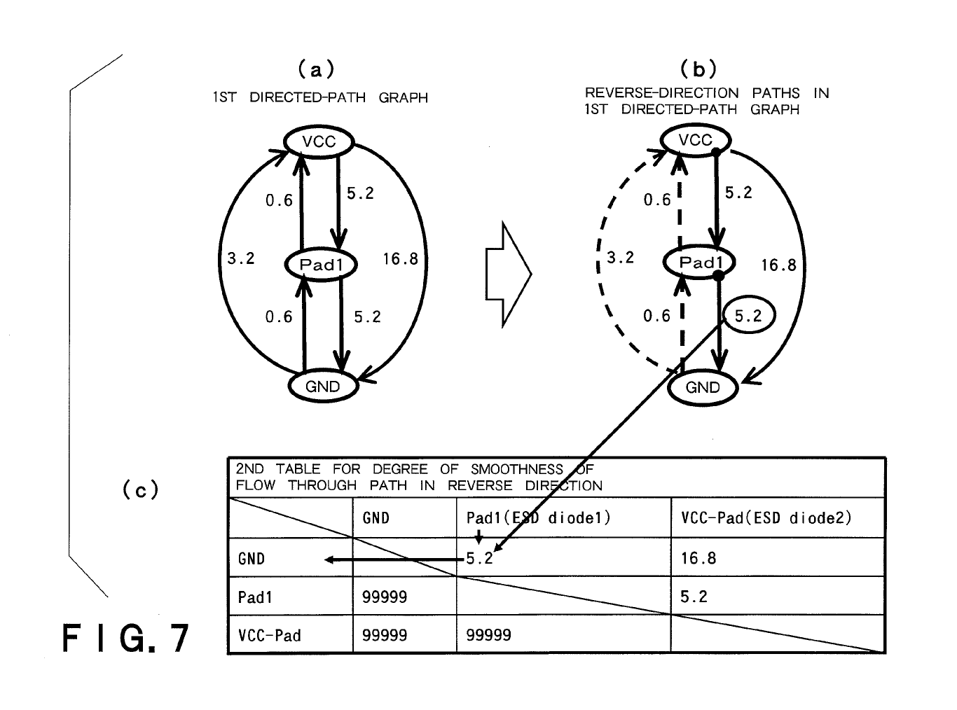

FIG. 7 is a view explaining a process of making the second table. FIG. 7(a) is the first directed-path graph shown in FIG. 6(b). The paths in the reverse direction are selected from FIG. 7(a) and indicated in FIG. 7(b) with a solid line, and the paths in the forward direction with a broken line. FIG. 7(c) is the second table corresponding to FIG. 7(b). In the second table of FIG. 7(c), the numerical values shown in FIG. 7(b) are described for the paths in the reverse direction whereas a very large value (such as, “99999”) is set for the paths in the forward direction.

Next, the first and second tables are combined to make a third table (step S7) which stores numerical values expressing the current-flowing-easiness of paths in the forward and reverse directions between any pads connected to an ESD protection element. The third table is made by comparing the corresponding numerical values between the first and second tables to select the smaller one.

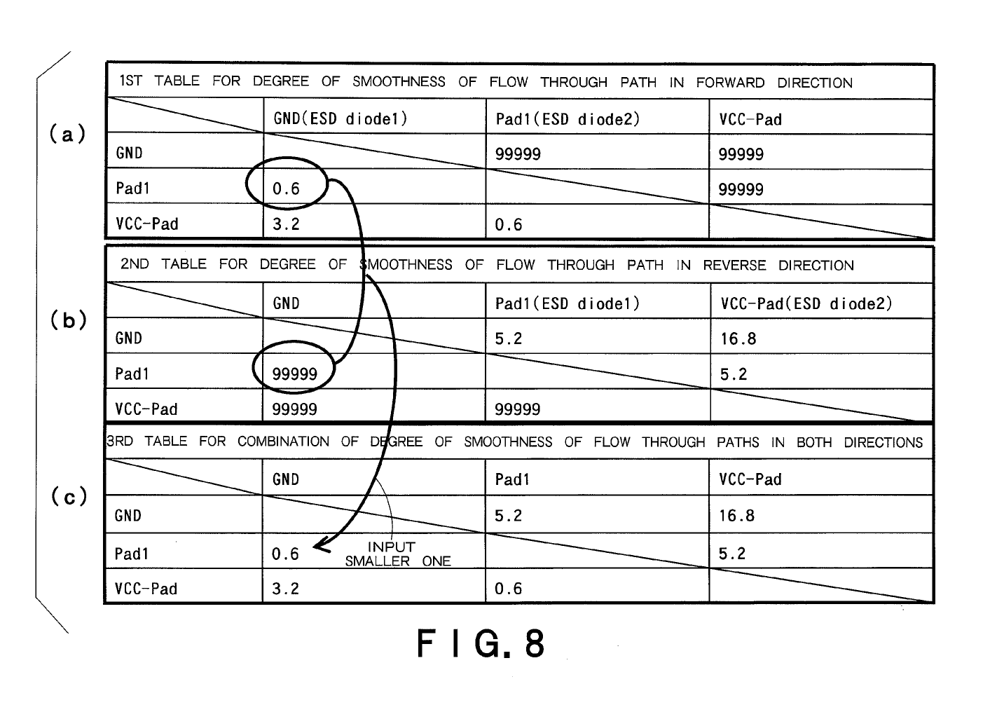

FIG. 8 is a view explaining a process of making the third table. FIG. 8(a) is the first table shown in FIG. 6(d). FIG. 8(b) is the second table shown in FIG. 7(c). FIG. 8(c) is the third table which stores the numerical values of the smaller one between the numerical values of the first and second tables. For example, when the numerical values are 0.6 and “99999” in the first and second tables, respectively, for a path from a diode of an ESD protection element to the pad P1, 0.6 is selected and stored in the third table. Accordingly, there is no very large value such as “999999” in the third table.

Next, a fourth table is made based on the third table (step S8) which stores numerical values expressing the current-flowing-easiness between any pads connected to an ESD protection element. A numerical value expressing the current-flowing-easiness of a path from a pad A to a pad B via a diode of an ESD protection element and a pad C is compared with another numerical value expressing the current-flowing-easiness of a path from the pads A to B via the diode of the ESD protection element (but not via the pad C). When the latter numerical value is smaller, the latter one is stored in the fourth table. Accordingly, the fourth table stores the numerical value of the path through which a current flows most easily when there is a plurality of paths from the pads A to B.

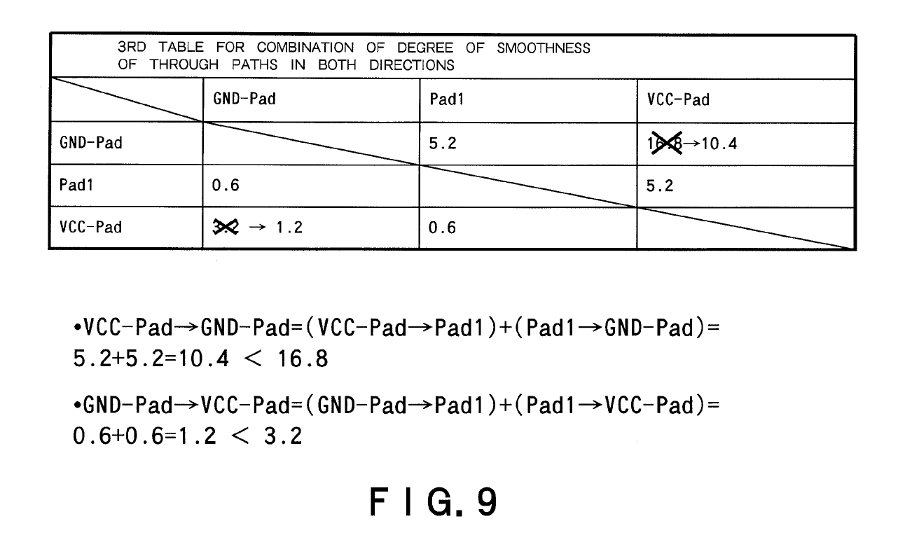

FIG. 9 is a view explaining a process of making the fourth table. The third table shown in FIG. 8(c) has a numerical value of 16.8 that indicates the current-flowing-easiness of a path from the VCC to GND pads. This numerical value indicates the current-flowing-easiness of a path via a diode of an ESD protection element. There is another path from the VCC to GND pads via a diode of an ESD protection element. A numerical value of this path that indicates the current-flowing-easiness is 10.4. The numerical value of 10.4 is smaller than 16.8. Therefore, the numerical value is updated to 10.4 in the fourth table. The numerical value of 10.4 is the sum of a numerical value of 5.2 of the path from the VCC pad to the pad P1 and another numerical value of 5.2 of the path from the pad P1 to the GND pad. Therefore, the path having the numerical value of 10. 4 is the path from the VCC to GND pads via the pad P1.

In the same way, in the paths from the GND to VCC pads, a numerical value of a path from the GND to VCC pads via a diode of an ESD protection element is 3.2 and that of a path from the GND pad to the pad P1 via an ESD protection element and from the pad P1 to the VCC pad is 1.2. Therefore, the numerical value is updated to 1.2 in the fourth table. The numerical value of 1.2 is the sum of a numerical value of 0.6 of the path from the GND pad to the pad P1 and another numerical value of 0.6 of the path from the pad P1 to the VCC pad. Therefore, the path having the numerical value of 1.2 is the path from the GND to VCC pads via the pad P1.

Next, the numerical values of the fourth table and those of a sixth table input previously by an operator through the input unit 3 are compared with each other (step S9). The sixth table stores design values of numerical values expressing the current-flowing-easiness of an ESD protection element between pads.

When a numerical value of the fourth table is smaller as a result of comparison between the fourth and sixth tables, it indicates that there is a path via an ESD protection element not assumed by an operator (a designer), a path via a parasitic diode of an ESD protection element, or a path between pads having another ESD protection element connected therebetween. Therefore, when a numerical value of the fourth table is smaller, the existence of a path not assumed is indicated through the output unit 4 (step S10).

On the other hand, when a numerical value of the sixth table is smaller as a result of comparison between the fourth and sixth tables, it indicates that there is no path via an ESD protection element not assumed by an operator (a designer). It is then indicated through the output unit 4 (step S11).

When a problematic path is indicated through the output unit 4 in step S10 or S11, the operator checks the reported path to examine whether there is an error in the connection of an ESD protection element, the type of the ESD protection element to be used, etc., and thus the operator modifies the first netlist and performs the processes from step S1 again when an error is found (step S12).

Nevertheless, the operator (designer) may not always prepare the sixth table beforehand. And hence, the processes in step S9 to S12 may not always be necessary. If the sixth table cannot be prepared, a process of step S13 explained below is performed after step S9. The process of step S13 is also performed when the numerical values of the fourth and sixth tables are equal to each other.

In step S13, a second directed-path graph is made by removing a directed path via a diode of an ESD protection element from the first directed-path graph.

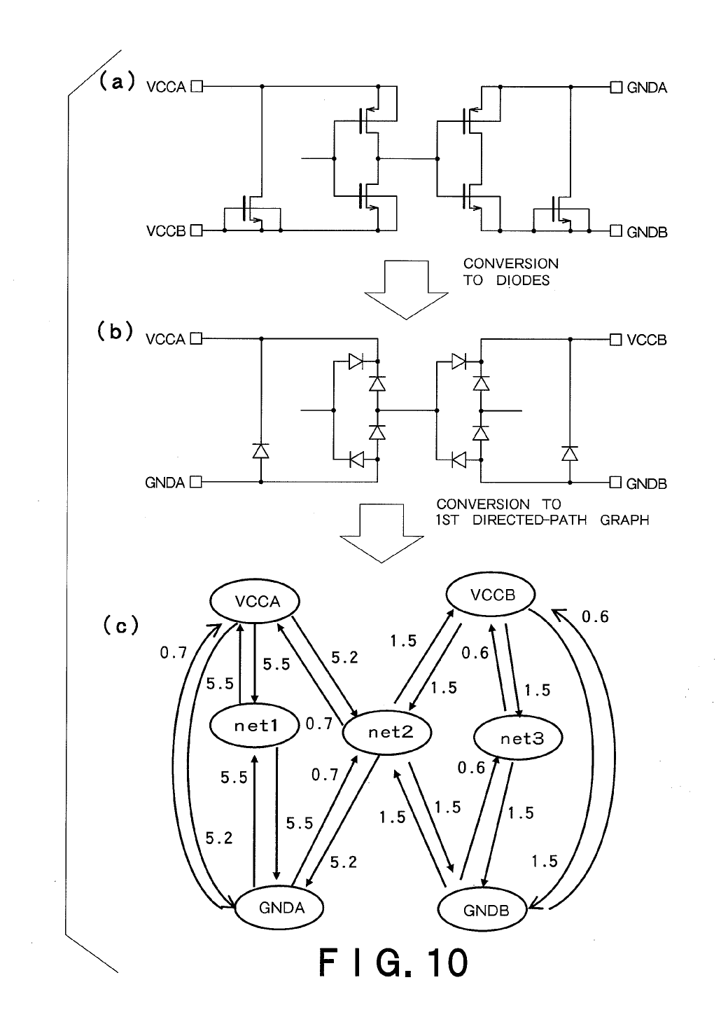

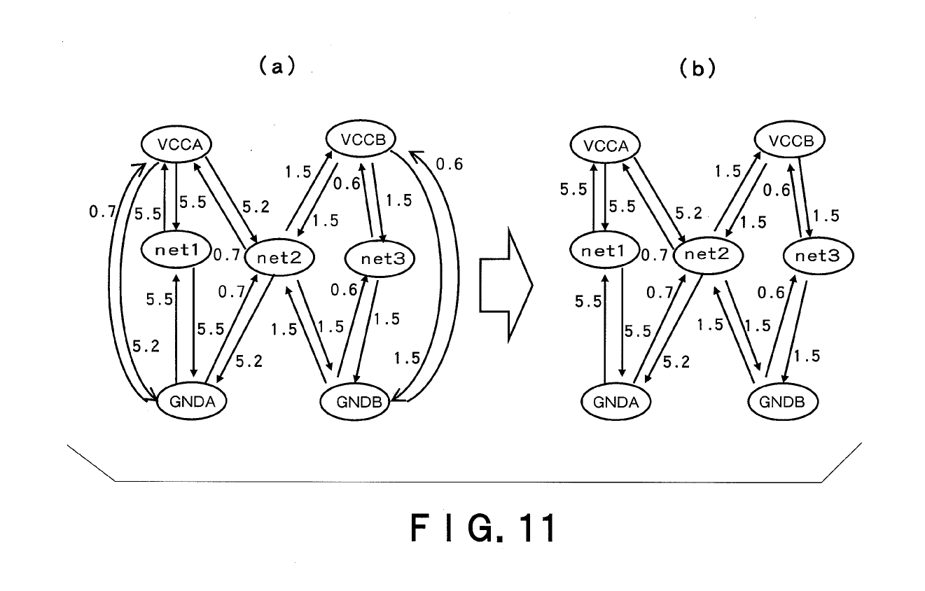

FIGS. 10 and 11 are views explaining the process of step S13. A circuit of FIG. 10(a) is replaced with a circuit having diodes and parasitic diodes, for example, shown in FIG. 10(b). After that, a first directed-path graph such as shown in FIGS. 10(c) and 11(a) is made by the process of step S4. After that, by the process of step S13, a second directed-path graph such as shown in FIG. 11(b) is made. As understood by comparing FIGS. 11(a) and 11(b), paths via diodes between VCCA and GNDA pads (the two paths on the left side of FIG. 11(a)) and paths via diodes between VCCB and GNDB pads (the two paths on the right side of FIG. 11(a)) are removed from the second directed-path graph.

Next, all paths in the forward and reverse directions between any pads are searched by using the second directed-path graph to verify whether the minimum value of the numerical value expressing the current-flowing-easiness of each path is smaller than the corresponding numerical value of the fourth table. When the minimum value of a path exceeds that of the same path in the fourth table during the process of calculating the sum of the numerical values of this path, the numerical calculation for this path may be stopped and another path may be searched (step S14).

The process of step S14 is performed for all pad pairs to make a fifth table (step S15).

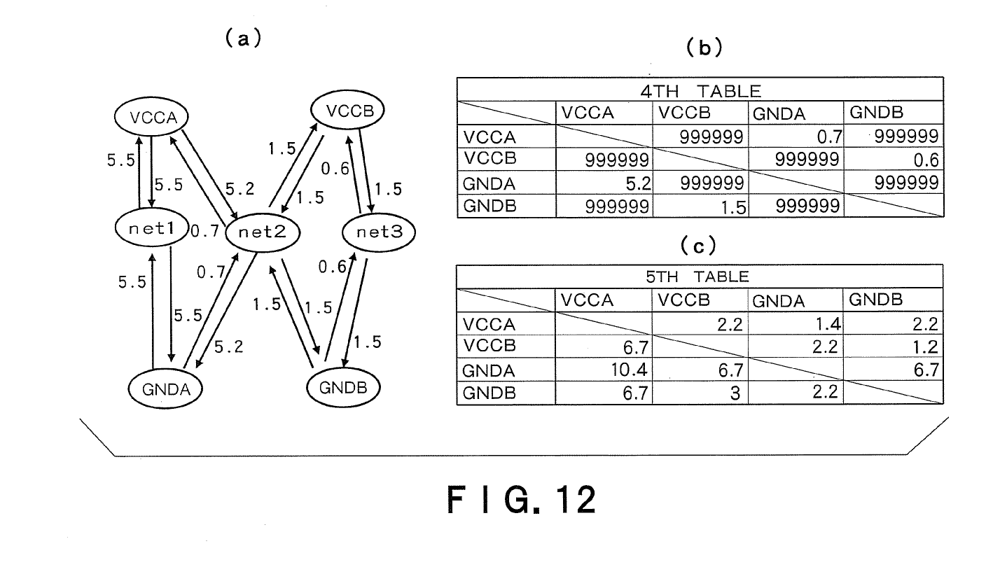

FIG. 12 is a view explaining a process of making the fifth table. FIG. 12(a) is the second directed-path graph shown in FIG. 11(b). FIG. 12(b) is the fourth table corresponding to the second directed-path graph of FIG. 11(b). The fourth table intends to store numerical values of only the paths connected to the ESD protection elements. Therefore, the numerical values of paths not connected to the ESD protection element are set at a very large value “99999”.

FIG. 12(c) shows one example of the fifth table which stores the numerical values of paths flowing a current most easily by searching all paths between pads at a state of removing all the ESD protection element.

As understood by comparing the fourth and fifth tables of FIGS. 12(b) and 12(c), respectively, the numerical value “99999” in the fourth table is updated to a smaller value for the same path in the fifth table. Moreover, if a path having a numerical value different from “99999” corresponds to a path flowing a current more easily without passing through an ESD protection element, the numerical value of the former path is updated to that of the latter path.

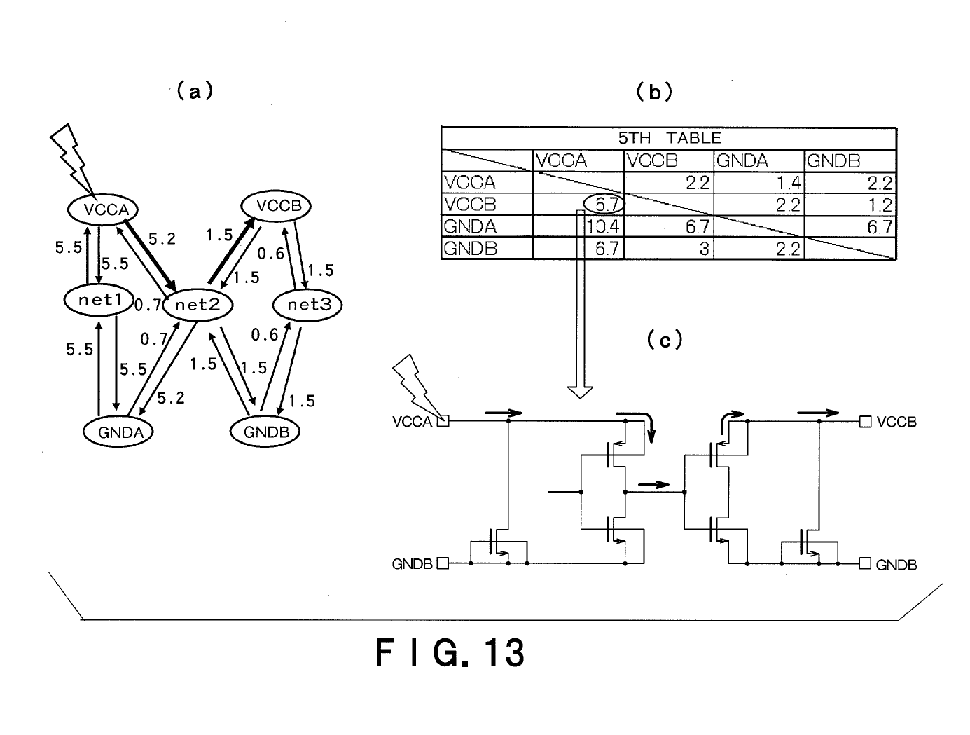

FIG. 13 is a view explaining the reason why a numerical value expressing the current-flowing-easiness of a path from the VCCA to VCCB pads becomes 6.7 in the fifth table. FIG. 13(a) is the second directed-path graph in the same way as in FIG. 12(a). FIG. 13(b) is the fifth table in the same way as in FIG. 12(c).

As shown in a circuit diagram of FIG. 13(c), there are MOS transistors Q1 and Q2 between the VCCA to VCCB pads. When a current flows from the VCCA to VCCB pads in the direction indicated by arrows in FIG. 13(c), a current enough to break down the MOS transistor Q2 and to penetrate a gate insulating film thereof flows inevitably. The fifth table is made under consideration that the MOS transistor Q2 is easily damaged in such a way.

In this embodiment, the fourth and fifth tables are compared with each other in order to exactly find out a current path through which such a large current mentioned above may flow (step S16). When a numerical value in the fifth table and that in the fourth table are different from each other, it is determined that the path corresponding to the numerical values is problematic, and the path and the corresponding pad pair are indicated to an operator through the output unit 4 (step S17).

It is unnecessary to indicate to the operator in step S17 every time where one path having a numerical value equal to or smaller than that of the fourth table is found out in step S16 described above. Step S17 may be performed when a specific number of such paths are found out.

When receiving the indication in step S17, the operator analyzes the problematic pad pair and path, and modifies the first netlist to solve the problem (step S18). After the modification, the processes of step S1 and the following steps described above are performed again and the processes of steps S1 to S18 are repeated until finally there is no problematic portion.

As described above, in this embodiment, the current-flowing-easiness between pads is analyzed after PN junctions and gate-to source capacitance in an ESD protection element and an internal circuit connected between pads of a semiconductor circuit are replaced with diodes. Therefore, according to the embodiment, it is possible to accurately analyze the current-flowing-easiness.

Moreover, in this embodiment, a path is searched for between pads via an unexpected ESD protection element, in addition to a path between pads via an expected ESD protection element. Therefore, according to the embodiment, it is possible to accurately detect a current path that is not expected for a designer.

Furthermore, in this embodiment, directed-path graphs showing the numerical values expressing the current-flowing-easiness are used to compare the numerical values expressing the current-flowing-easiness between pads via an ESD protection element with the numerical values determined by design beforehand. Therefore, according to the embodiment, it is achieved to easily and accurately verify whether there is an error in the connection of an ESD protection element.

Still furthermore, in this embodiment, a directed-path graph made for the case where an ESD protection element is connected and another directed-path graph made for the case where no ESD protection element is connected are compared with each other. Therefore, according to the embodiment, it is achieved to detect all paths through which a current flows smoothly but not via an ESD protection element, and easily and speedily perform a modification operation to problematic paths.

At least part of the ESD verification apparatus explained in the embodiment may be configured with hardware or software as described above. When the ESD verification apparatus is configured with software, a program that performs at least part of the functions of the ESD verification apparatus may be stored in a storage medium such as a flexible disk and CD-ROM, and then installed in a computer to run thereon. The storage medium may not be limited to a detachable one such as a magnetic disk and an optical disk but may be a standalone type such as a hard disk drive and a memory.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An ESD verification apparatus for a semiconductor circuit which comprises a plurality of pads, an internal circuit connected to the pads and at least one of an ESD protection element connected to two pads in the plurality of pads, comprising:
a replacement part configured to replace each PN junction part in the internal circuit and the ESD protection element, a gate-to-source capacitance and a capacitor with a rectifier, respectively;
a first table making part configured to make a first table which stores a numerical value expressing current-flowing-easiness of a current path flowing from one end to another end of the ESD protection element between the two pads connected to the ESD protection element for each of the ESD protection element;
a second table making part configured to make a second table which stores a numerical value expressing current-flowing-easiness of a current path flowing from another end to one end of the ESD protection element between the two pads connected to the ESD protection element for each of the ESD protection element;
a third table making part configured to make a third table which selects and stores a numerical value expressing current-flowing-easiness of a current path flowing more easily in current paths between two pads connected to the ESD protection element in the first and second tables;
a fourth table making part configured to make a fourth table which stores numerical values expressing current-flowing-easiness of all current paths via the ESD protection element between any pads among the plurality of pads based on the third table;
a fifth table making part configured to make a fifth table which stores numerical values expressing current-flowing-easiness between any pads in the plurality of pads at a state of removing all the ESD protection element from the semiconductor circuit;
a comparator configured to compare current-flowing-easiness of a current path via the ESD protection element with current-flowing-easiness of a current path not via the ESD protection element between any pads in the plurality of pads based on the fourth and fifth tables; and
an indicator configured to indicate to an operator a combination and a path of the corresponding pads when the comparator determines that current-flowing-easiness of a current path via the ESD protection element does not coincide with current-flowing-easiness of a current path not via the ESD protection element between any pads in the plurality of pads.

2. The ESD verification apparatus of claim 1, further comprising:
a sixth table making part configured to make a sixth table which stores designed numerical values expressing current-flowing-easiness of a current path between any pads connected to the ESD protection element for each of the ESD protection element; and
a verification part configured to verify whether ESD protection element is connected properly based on the fourth table and the sixth table.

3. The ESD verification apparatus of claim 2, wherein the verification part indicates to an operator that the semiconductor circuit is different from a designed circuit when a numerical value in the sixth table is smaller than the corresponding value in the fourth table.

4. The ESD verification apparatus of claim 1, wherein when numerical values are calculated in order while tracking current paths between any pads and one of the calculated numerical values exceeds a numerical value on the fourth table, the tracking is suspended.

5. The ESD verification apparatus of claim 1, wherein the first table making part calculates a numerical value expressing current-flowing-easiness for each of the rectifier, and stores a minimum value of a sum of the calculated numerical value into the first table.

6. The ESD verification apparatus of claim 1, wherein the fourth table making part makes the fourth table by setting a numerical value expressing current-flowing-easiness between any pads with no current path via the ESD protection element, to a predetermined value.

7. The ESD verification apparatus of claim 1, wherein when a current path flowing a current more easily exists in current paths not via the ESD protection element, the fifth table making part makes the fifth table by replacing a numeral value of the corresponding current path in the fourth table with a numerical value expressing current-flowing-easiness of the existed current path.

8. An ESD verification method of a semiconductor circuit which comprises a plurality of pads, an internal circuit connected to the pads and at least one of an ESD protection element connected to two pads in the plurality of pads, comprising:
replacing each PN junction part in the internal circuit and the ESD protection element, a gate-to-source capacitance and a capacitor with a rectifier, respectively;
making a first table which stores a numerical value expressing current-flowing-easiness of a current path flowing from one end to another end of the ESD protection element between the two pads connected to the ESD protection element for each of the ESD protection element;
making a second table which stores a numerical value expressing current-flowing-easiness of a current path flowing from another end to one end of the ESD protection element between the two pads connected to the ESD protection element for each of the ESD protection element;
making a third table which selects and stores a numerical value expressing current-flowing-easiness of a current path flowing more easily in current paths between two pads connected to the ESD protection element in the first and second tables;
making a fourth table which stores numerical values expressing current-flowing-easiness of all current paths via the ESD protection element between any pads among the plurality of pads based on the third table;
making a fifth table which stores numerical values expressing current-flowing-easiness between any pads in the plurality of pads at a state of removing all the ESD protection element from the semiconductor circuit;
comparing current-flowing-easiness of a current path via the ESD protection element with current-flowing-easiness of a current path not via the ESD protection element between any pads in the plurality of pads based on the fourth and fifth tables; and
indicating to an operator a combination and a path of the corresponding pads when the comparator determines that current-flowing-easiness of a current path via the ESD protection element does not coincide with current-flowing-easiness of a current path not via the ESD protection element between any pads in the plurality of pads.

9. The ESD verification method of claim 8, further comprising:
making a sixth table which stores designed numerical values expressing current-flowing-easiness of a current path between any pads connected to the ESD protection element for each of the ESD protection element; and
verifying whether ESD protection element is connected properly based on the fourth table and the sixth table.

10. The ESD verification method of claim 9, wherein the verification part indicates to an operator that the semiconductor circuit is different from a designed circuit when a numerical value in the sixth table is smaller than the corresponding value in the fourth table.

11. The ESD verification method of claim 8, wherein when numerical values are calculated in order while tracking current paths between any pads and one of the calculated numerical values exceeds a numerical value on the fourth table, the tracking is suspended.

12. The ESD verification method of claim 8, wherein the first table making part calculates a numerical value expressing current-flowing-easiness for each of the rectifier, and stores a minimum value of a sum of the calculated numerical value into the first table.

13. The ESD verification method of claim 8, wherein the fourth table making part makes the fourth table by setting a numerical value expressing current-flowing-easiness between any pads with no current path via the ESD protection element, to a predetermined value.

14. The ESD verification method of claim 8, wherein when a current path flowing a current more easily exists in current paths not via the ESD protection element, the fifth table making part makes the fifth table by replacing a numeral value of the corresponding current path in the fourth table with a numerical value expressing current-flowing-easiness of the existed current path.

15. A computer-readable storage medium which stores a program causing a computer to make ESD verification of a semiconductor circuit which comprises a plurality of pads, an internal circuit connected to the pads and at least one of an ESD protection element connected to two pads in the plurality of pads, the program comprising:
replacing each PN junction part in the internal circuit and the ESD protection element, a gate-to-source capacitance and a capacitor with a rectifier, respectively;
making a first table which stores a numerical value expressing current-flowing-easiness of a current path flowing from one end to another end of the ESD protection element between the two pads connected to the ESD protection element for each of the ESD protection element;
making a second table which stores a numerical value expressing current-flowing-easiness of a current path flowing from another end to one end of the ESD protection element between the two pads connected to the ESD protection element for each of the ESD protection element;
making a third table which selects and stores a numerical value expressing current-flowing-easiness of a current path flowing more easily in current paths between two pads connected to the ESD protection element in the first and second tables;
making a fourth table which stores numerical values expressing current-flowing-easiness of all current paths via the ESD protection element between any pads among the plurality of pads based on the third table;
making a fifth table which stores numerical values expressing current-flowing-easiness between any pads in the plurality of pads at a state of removing all the ESD protection element from the semiconductor circuit;
comparing current-flowing-easiness of a current path via the ESD protection element with current-flowing-easiness of a current path not via the ESD protection element between any pads in the plurality of pads based on the fourth and fifth tables; and
indicating to an operator a combination and a path of the corresponding pads when the comparator determines that current-flowing-easiness of a current path via the ESD protection element does not coincide with current-flowing-easiness of a current path not via the ESD protection element between any pads in the plurality of pads.

16. The ESD verification medium of claim 15, further comprising:
making a sixth table which stores designed numerical values expressing current-flowing-easiness of a current path between any pads connected to the ESD protection element for each of the ESD protection element; and
verifying whether ESD protection element is connected properly based on the fourth table and the sixth table.

17. The ESD verification medium of claim 16, wherein the verification part indicates to an operator that the semiconductor circuit is different from a designed circuit when a numerical value in the sixth table is smaller than the corresponding value in the fourth table.

18. The ESD verification medium of claim 15, wherein when numerical values are calculated in order while tracking current paths between any pads and one of the calculated numerical values exceeds a numerical value on the fourth table, the tracking is suspended.

19. The ESD verification medium of claim 15, wherein the first table making part calculates a numerical value expressing current-flowing-easiness for each of the rectifier, and stores a minimum value of a sum of the calculated numerical value into the first table.

20. The ESD verification medium of claim 15, wherein the fourth table making part makes the fourth table by setting a numerical value expressing current-flowing-easiness between any pads with no current path via the ESD protection element, to a predetermined value.
